(19) United States
(12) Patent Application Publication
(10) Pub. No.: US 2010/0117420 A1
(43) Pub. Date: May 13, 2010

(54) VEHICLE SEAT

(75) Inventor: Thomas Frotz, Burscheid (DE)

Correspondence Address: DOBRUSIN & THENNISCH PC, 29 W LAWRENCE ST, SUITE 210, PONTIAC, MI, 48342, US

(73) Assignee: Johnson Controls GmbH, Burscheid (DE)

(21) Appl. No.: 12/529,598

(22) PCT Filed: Feb. 22, 2008
(86) PCT No.: PCT/EP2008/001428

§ 371 Date: Sep. 2, 2009

(30) Foreign Application Priority Data
Mar. 6, 2007 (DE) 10 2007 011 296.5
Jun. 29, 2007 (DE) 10 2007 030 428.7

(51) Int. Cl. B60N 2/30; B60N 2/02

(52) U.S. Cl. 297/284.1

(57) ABSTRACT

The present invention relates to a vehicle seat (1), particularly a rear seat or rear seat bench for a motor vehicle, having a back rest (2) and a seat part (3), wherein the back rest (2) can be moved from a use position to a storage position and, in so doing, at least the shape of the back rest (2) changes and the seat part (3), and/or the back rest (2) has a plurality of means (6) disposed parallel to one another extending substantially over the entire length of the seat part (3) or back rest (2), the shape of said means changing in a reversible fashion when the back rest is moved from the use position to the storage position.

The invention relates to a vehicle seat, in particular a rear seat or a rear seat bench for a motor vehicle, with a backrest and a seat part, wherein the backrest can be transferred from a use position into a storage position and, in the process, at least the shape of the backrest changes.

Vehicle seats of this type are known from the prior art, for example from U.S. Pat. Nos. 6,199,951, 6,123,380, DE 103 51 157 33, WO 2004/043730 A2 and WO 2004/043207 A2. However, the vehicle seats described therein are either of comparatively complicated construction or do not provide a sufficient level of comfort.

It was therefore the object of the present invention to provide a vehicle seat which does not have the disadvantages of the prior art.

The object is achieved by a vehicle seat, in particular a rear seat or a rear seat bench for a motor vehicle, with a backrest and a seat part, wherein the backrest can be transferred from a use position into a storage position and, in the process, at least the shape of the backrest changes, and the seat part and/or the backrest have/has a multiplicity of means which are arranged parallel next to one another, extend substantially over the entire length of the seat part or of the backrest and the shape of which changes reversibly when the backrest is transferred from the use position into the storage position.

The vehicle seat according to the invention provides the seat occupant with a good level of comfort in the use position. When the backrest is folded forward onto the seat part, it can be folded to form a flat package.

The vehicle seat according to the invention can be produced simply and cost-effectively.

A vehicle seat within the context of the invention is any vehicle seat at any location within the vehicle. One or more individuals can sit on the vehicle seat, and therefore it may also be a bench which can also have a divided backrest. The vehicle seat is preferably a rear seat.

According to the invention, the vehicle seat has a backrest and a seat part, wherein the backrest can be transferred from a use position into a storage position and, in the process, at least the shape of the backrest changes. In the storage position, the backrest and/or the seat part are/is flat such that the vehicle seat can be folded up to form a flat package. By contrast, in the use position, the seat part and/or the backrest have a curved shape which preferably is matched to the body of the seat occupant and increases the seating comfort thereof.

For this purpose, the vehicle seat has, in the backrest and/or in the seat part, a multiplicity of means extending substantially over the entire length of the seat part or the backrest. In this case, the means are arranged next to one another over the width of the backrest and/or of the seat part. The length of said means is selected in such a manner that they extend substantially over the entire length of the backrest and/or over the entire length of the seat part. According to the invention, the shape of said means changes reversibly when the backrest is transferred from the use position into the storage position; i.e. they are deformed only elastically and not plastically.

These means are preferably strips, particularly preferably made of a semi-rigid material. Semi-rigid within the context of the invention means that the strips can be bent with average human forces. The strips can be manufactured from plastic, metal or wood or a combination of said materials, with a material which does not splinter upon breaking being preferred.

A multiplicity of said strips are arranged next to one another, with the width and number of said strips being such that essentially the entire width of the backrest and/or of the seat part is covered by strips. The strips are arranged substantially parallel to one another. The higher the number of strips, the greater the level of comfort. The strips are preferably mounted on the vehicle seat according to the invention and/or on the cover thereof in such a manner that the curvature of said strips can be set individually. This embodiment according to the invention in particular increases the seating comfort.

The vehicle seat preferably has an axis about which the backrest is rotatably arranged and with respect to which the means are arranged perpendicularly. Said axis is generally oriented transversely with respect to the direction of movement of the vehicle. The means, the shape of which changes when the backrest is transferred from the use position into the storage position, are preferably arranged perpendicularly and next to one another along said axis.

As a rule, the vehicle seat has a. cover. Preferably, the semi-rigid strips are particularly preferably each arranged in a pocket of the seat cover. As a result, their position within the vehicle seat is defined. The strips are particularly preferably mounted in an at least partially displaceable manner within the pockets.

The strips are preferably connected fixedly to the vehicle seat at their end pointing in the direction of the axis of rotation of the backrest. The strips are particularly preferably connected movably to the vehicle seat at their end pointing away from the axis of rotation of the backrest.

In a further preferred embodiment, the vehicle seat has [additional] means, preferably bands, particularly preferably steel bands, which are arranged displaceably on the backrest and are preferably embedded therein. When the backrest is transferred from the storage position into the use position and vice versa, said bands are displaced and bring about the change in shape of the backrest and/or of the seat part.

The bands can be manufactured from plastic, metal or wood or a combination of said materials, with a material which does not splinter upon breaking being preferred. However, the bands are preferably made of steel.

The bands are preferably arranged substantially congruently to the strips. The bands are particularly preferably located below the strips.

The bands are preferably dimensioned in their length in such a manner and/or arranged in the vehicle seat in such a manner that, in the storage position, they protrude with their one end out of the backrest or the seat part. Said end is particularly preferably pushed at least partially into the backrest or the seat part when the backrest is transferred from the storage position into the use position. This movement causes the strips to be bent. When the backrest is transferred into the storage position, the bands migrate again out of the backrest or the seat part such that the curvature of the backrest or of the seat part disappears. In the use position, this end of the bands is preferably supported on the backrest or the seat part such that the curved shape thereof is maintained even when subjected to a load, for example by means of a seat occupant.

[Further] means are preferably arranged between the means, for example the strips, and the [additional] means, for example the bands, in such a manner that the one end of said [further] means is connected, preferably riveted, to a means, for example the strip, and the other end of said [further] means is connected preferably riveted, in each case to an [additional] means (8), for example the band. By means of said [further] means, the movement of the bands is converted into a change in shape of the strips.

The [further] means are preferably semi-elastic strips. These strips can be manufactured from plastic, metal or wood or a combination of said materials, with a material which does not splinter upon breaking being preferred.

Said [further] means preferably bend upon transfer from the storage position into the use position, as a result of which strips below the cover are curved outward and thus reversibly bring about the curvature of the backrest and/or of the seat part.

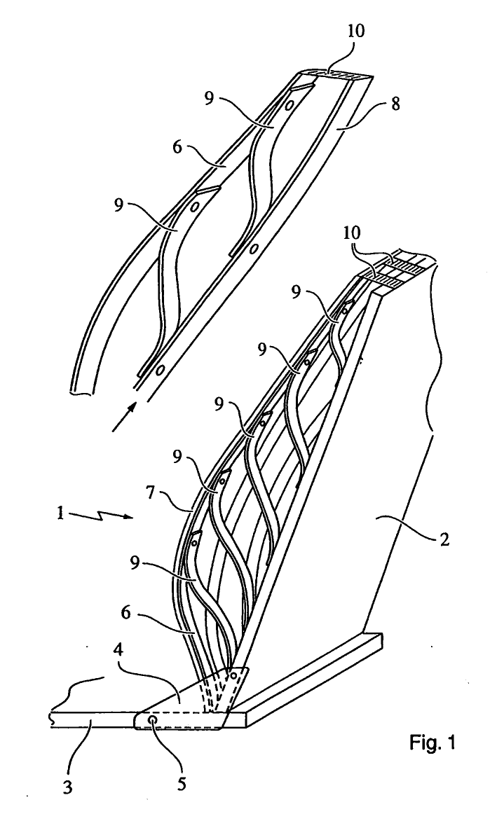

The invention is explained below with reference to FIGS. 1-3. These explanations are merely by way of example and do not restrict the general inventive concept. The directional details refer in each case to the backrest in the use position.

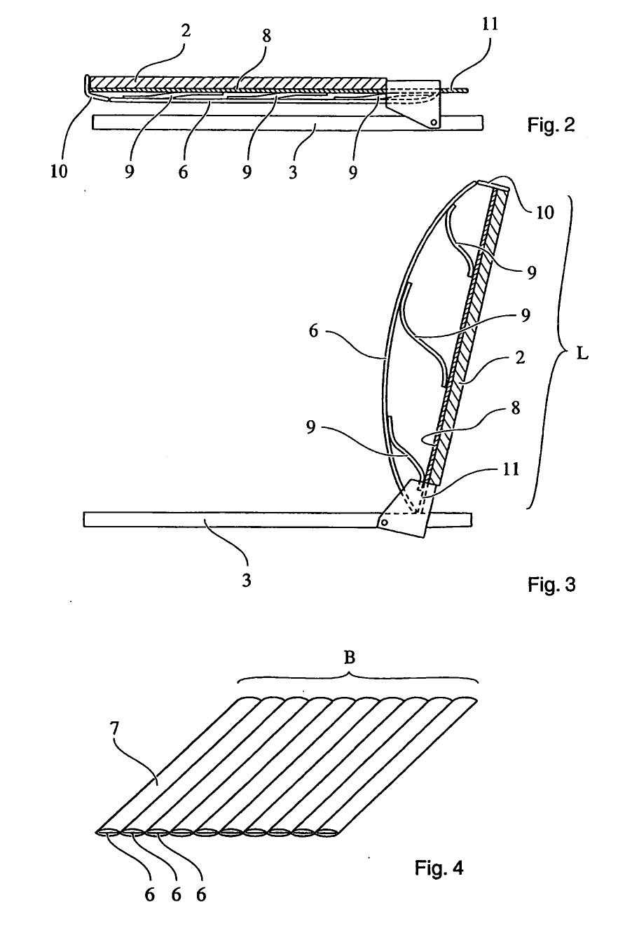

FIGS. 1 and 2 show an embodiment of the vehicle seat according to the invention.

FIG. 3 shows the strips in the pockets.

The vehicle seat 1 shown in FIG. 1 comprises backrest 2 and a seat part 3. The backrest 2 is fastened to the seat part 3 in a manner such that it can rotate about a forwardly offset axis 5 by means of a protruding bracket (1) and can be folded from its upright use position (FIGS. 1, 3) into a horizontal storage position (FIG. 2). On the flat side of the backrest 2, which side faces the seat occupant, a multiplicity of semi-rigid strips 6 (for example made of plastic, for example polypropylene) are arranged parallel to one another and at right angles to the axis 5 below the seat cover 7. The length of the strips substantially corresponds to the length I of the backrest. So many strips are arranged next to one another that essentially the entire width B of the backrest has strips 6. The strips 6 may differ in width, but they preferably have the same width. Rigid steel bands 8 which protrude downward out of the backrest 2 are embedded in the backrest 2, substantially congruently to the strips 6, in a manner such that they are displaceable along their longitudinal extent and are connected via a number of strip pieces 9 made of a semi-rigid material to the respectively assigned strips 6. The strip pieces 9 run, spaced apart from one another in the longitudinal extent of the steel band 8 in question, between the strips 6 and the steel bands 8 and are fastened, in particular riveted, at their end pointing in the direction of the axis 5 to the steel band 8 and at their opposite end to the strip 6. That end of each strip 6 which faces the axis 5 is connected fixedly to the lower region of the backrest 2 while the opposite ends of the strips 6 are connected to the upper end of the backrest 2 via a fabric tape 10.

In the storage position of the backrest 2 (FIG. 2), the steel, bands 8 are pushed out of the lower end of the backrest 2, as a result of which the mutually associated strips 6, strip pieces 9 and steel bands 8 can be placed flat on one another. When the backrest 2 is set. upright (FIG. 3), the protruding ends 11 of the steel bands strike against the seat part 3, as a result of which the steel bands 8 are displaced upward relative to the backrest 2 and strips 6. The strip pieces 9 are expanded in an S-shaped manner in the process, with the strips 6 curving away forward in an elastically resilient manner from the backrest 2. The contour of the curvature is determined by the length of the end 11 and of the strip pieces 9 and can be predetermined such that it differs, if appropriate also such that it can be set, over the width of the backrest 2. FIG. 4 shows a multiplicity of strips 6 which are arranged next to one another and are inserted into the seat cover 7 in the manner of pockets.

In principle, the invention can also be used for a reversible curvature of the seat part 3.

### LIST OF DESIGNATIONS

1 Vehicle seat
2 Backrest
3 Seat part
4 Bracket
5 Axis
6 Strip
7 Seat cover
8 Steel band
9 Strip pieces
10 Fabric tape
11 End (of the steel band 8)
L Length of the backrest or of the seat part
B Width of the backrest or of the seat part

1. A vehicle seat with a backrest and a seat part, wherein the backrest can be transferred from a use position into a storage position and, in the process, at least the shape of the backrest changes, characterized in that the seat part and/or the backrest have/has a multiplicity of semi-rigid strips which are arranged parallel next to one another, extend substantially over the entire length of the seat part or of the backrest and the shape of which changes reversibly when the backrest is transferred from the use position into the storage position.

2. The vehicle seat as claimed in claim 1, characterized in that it has an axis about which the backrest is rotatably arranged and with respect to which the semi-rigid strips are arranged perpendicularly.

3. (canceled)

4. The vehicle seat as claimed in claim 2, characterized in that it has a cover, and in that the semi-rigid strips are preferably each arranged in a pocket of the seat cover.

5. The vehicle seat as claimed in claim 2, characterized in that the strips are connected fixedly to the vehicle seat at their end pointing in the direction of the axis

6. The vehicle seat as claimed in claim 2, characterized in that the strips are connected movably to the vehicle seat at their end pointing away from the axis

7. The vehicle seat as claimed in claim 1, characterized in that it has bands, which are arranged displaceably on the backrest and are embedded therein.

8. The vehicle seat as claimed in claim 7, characterized in that the bands are arranged substantially congruently to the strips

9. The vehicle seat as claimed in claim 1, characterized in that the bands are displaced when the backrest is transferred from the use position into the storage position and vice versa.

10. The vehicle seat as claimed in claim 6 characterized in that, in the storage position, the bands protrude at their end out of the backrest or the seat part

11. The vehicle seat as claimed in claim 10, characterized in that, when the backrest is transferred from the storage position into the use position, the end is at least partially pushed into the backrest or the seat part.

12. The vehicle seat as claimed in claim 10, characterized in that, in the use position, the end is supported on the backrest or the seat part.

13. The vehicle seat as claimed in claim 1, characterized in that connection means are arranged between the semi-rigid strips and the bands with in each case one end of the connection means being connected, in each case to a semi-rigid strips and in each case the other end of the connection means being connected in each case to bands.

14. The vehicle seat as claimed in claim 13, characterized in that the connection means are semi-elastic strips.

15. The vehicle seat as claimed in claim 13, characterized in that the connection means bend upon transfer from the storage position into the use position.
